(19) United States
(12) Patent Application Publication
(10) Pub. No.: US 2025/0007201 A1
(43) Pub. Date: Jan. 2, 2025

(54) MODULAR PLUG CONNECTOR FOR CONTACTING A CIRCUIT BOARD PLUG CONNECTOR

(71) Applicant: Weidmüller Interface GmbH & Co. KG, Detmold (DE)

(72) Inventors: Marc Neu, Kalletal (DE); Marvin Krecht, Löhne (DE); Tobias Langer, Lemgo (DE); Meikel Reilender, Lemgo (DE)

(21) Appl. No.: 18/709,586

(22) PCT Filed: Nov. 15, 2022
(86) PCT No.: PCT/EP2022/081962

§ 371 Date: May 13, 2024

(30) Foreign Application Priority Data
Nov. 19, 2021 (DE) 10 2021 130 351.6

(51) Int. Cl. H01R 13/514; H01R 13/717

(52) U.S. Cl. CPC H01R 13/514; H01R 13/7175

(57) ABSTRACT

A modular plug connector in a strip-shaped design, which can be plugged together with a corresponding mating plug connector, in particular a circuit board plug connector has a plurality of modules arranged in series and mechanically connected to one another directly with mechanical connectors to form the strip shape. There are multiple plug modules and one or more electronics modules, wherein the respective electronics module has two housing limbs orientated at an angle to one another, of which one is a series-mounting limb that can be mounted in series between two of the plug modules and the other is a transverse limb orientated at an angle, in particular a right angle, thereto and which is arranged on a housing side of one or more of the plug modules. The housing side is orientated at an angle, in particular at a right angle, to series-mounting direction x.

The invention relates to a modular plug connector for contacting a mating plug connector, in particular a circuit board plug connector, and an electronics module for such a modular plug connector.

A wide variety of modular plug connectors are known from the prior art. The term “modular plug connector” includes a plug connector of strip-shaped design which can be plugged together with a corresponding mating plug connector, in particular with a circuit board plug connector, wherein the modular plug connector has a number of modules which are arranged in series and mechanically connected together directly with mechanical connecting means into a strip shape. At least some of the modules are configured as plug modules which each have a module housing, at least one plugging face with at least one plugging contact and preferably each have at least one conductor terminal.

### SUMMARY OF THE INVENTION

The object of the invention is to produce a modular plug connector which has an expanded functionality and a nevertheless simple and versatile structure that can be adapted to various applications.

accordingly, it is an object of the present application to provide a modular plug connector with a strip-shaped design, which can be plugged together with a corresponding mating plug connector, in particular a circuit board plug connector. The modular plug connector has a plurality of modules arranged in series and mechanically connected to one another directly with mechanical connectors to form the strip shape. There are multiple plug modules and one or more electronics modules, wherein the respective electronics module has two housing limbs orientated at an angle to one another, of which one is a series-mounting limb that can be mounted in series between two of the plug modules and the other is a transverse limb orientated at an angle, in particular a right angle, thereto and which is arranged on a housing side of one or more of the plug modules. The housing side is orientated at an angle, in particular at a right angle to series-mounting direction x.

The plug connector is thus provided in a structurally simple manner with one or multiple electronics modules, with which a wide range of functions can be performed on the plug connector. The individual plug modules are simply and stably joined together with the respective electronics housing to form a compound structure.

According to one embodiment, the transverse limb rests on the neighboring plug modules. This is not mandatory, but it is advantageous if a stable bearing is implemented on the plug modules.

According to another embodiment, the plug modules each have at least one metal assembly with at least one plug terminal and with at least one further terminal, in particular a conductor terminal. Further, the respective transverse limb of the respective terminal housing for the plug module(s), which it engages over, has at least one measuring device, in particular a measuring contact or a contactless measuring sensor, which it contacts the metal assembly of the respective plug module with, comes to rest with, or it is arranged in the vicinity of the metal assembly in the plugged-together state. In each case, measurements, for example temperature measurements, can be carried out on the metal assembly or in the vicinity of the metal assembly.

This results in a one-off or preferably repeated or continuous tapping of measurement values at the respective plug module in a simple manner.

From the structural point of view, it is preferred and simple if the module housing of the electronics module has an L-shape or a T-shape in a side view. It can be envisaged in particular that the series-mounting limb and the plug housing have corresponding mechanical connecting means at which they can be affixed to one another in a row. In this way, the electronics modules are integrated particularly simply into the plug connector and nevertheless can have a relatively large housing for accommodating electrical components such as printed circuit board assemblies and the like that are also able to be used for additional functionalities, if required.

According to another embodiment, the plug connector modules are not held in a holding frame, but rather that they are mechanically connected to one another directly at their series-mounting sides. Thus a modular plug connector with terminal modules of different design can be produced without a holding frame.

According to a further embodiment, the plug modules each have a series-mounting front side and a series-mounting rear side, wherein the series-mounting front side and the series-mounting rear side of the module housings and the series-mounting limbs of the electronics modules have mechanical connecting mechanisms which correspond to plug connector modules which are series-mounted directly to one another.

It is simple and expedient if the corresponding mechanical connecting mechanisms have one or more locking hooks and one or more corresponding locking traps, which form locking mechanisms which are locked to one another on plug connector modules which are series-mounted to one another.

According to yet another embodiment, it is furthermore simple and expedient if the corresponding mechanical connecting mechanisms have one or more pegs and one or more corresponding receiving holes. Preferably, the peg or pegs have a non-round, in particular polygonal cross-section and the receiving hole or holes have a corresponding, in particular polygonal cross-section, since this offers security against relative twisting of module housings which are series-mounted to one another.

It is structurally advantageous and simple if the measuring device, in particular the respective measuring contact or the respective contactless measurement sensor, engages the plug housing and contacts the metal assembly, in particular a busbar of the metal assembly, at a surface there or that it is situated in the vicinity of this metal assembly. Alternatively, it can contact the metal assembly differently, such as by plugging.

In yet a further embodiment, the respective electronics module has an evaluation device with which a measurement value received at one of the plug modules can be evaluated and/or displayed if it has a display device, in particular at least one LED.

In another embodiment, a plurality of the electronics modules are provided whose transverse limbs adjoin one another. The transverse limbs have bus contacts which contact one another such that, preferably when the plug connector is in the mounted-together state, a data and energy bus is configured which extends up to a communication module of the plug connector, to which a higher-level unit can be connected.

It is further an object of the disclosure to provide the advantageous use of an electronics module of a plug connector as described herein to perform a measurement and to display, evaluate and/or output a measurement result. The measurement can be or include a measurement of temperature and/or the measurement can be or include a measurement of voltage or current.

It is also the object of the disclosure to provide a method of measuring the voltage or the temperature of a conductor terminal or the current through the conductor terminal, at a modular plug connector, which includes the steps of providing the modular plug connector, measuring a temperature, a voltage or current at the metal assembly of the respective plug module with a measuring device which contacts, or is situated in the vicinity of, the metal assembly of the plug module, into which it is plugged, and displaying the temperature or a result of the measurement or forwarding the measurement to a communication module.

In particular, a temperature can be measured in the vicinity of the metal assembly. If necessary, a coefficient of correction for the spacing is taken into account when measured. Moreover, currents can be measured indirectly without touching such as by detection of magnetic fields or the like.

### BRIEF DESCRIPTION OF THE DRAWINGS

The invention is described hereinafter with reference to the drawings by means of exemplary embodiments. The figures illustrate the invention by means of these exemplary embodiments. The invention is not limited to these examples, but rather can also be implemented in another manner literally or equivalently. In particular, individual advantageous features of the exemplary embodiments depicted below can also be implemented in other exemplary embodiments which are not depicted. In the drawings:

FIG. 1a is a perspective view of a fully assembled strip-like modular plug connector which can be plugged together with a mating plug connector such as a modular circuit board plug connector;

FIG. 1b is a perspective view of the plug connector from 1a with a housing cover and a communication module removed;

FIGS. 1c and 1d are two different perspective views of the plug connector from FIG. 1a with a side cover and communication module removed;

FIGS. 2a and 2b are different perspective views of three plug connector modules of the plug connector from 1a in a non-locked-together state with the modules being depicted individually including two plug modules and an electronics module;

FIG. 2c is an exploded view of the modules from FIGS. 2a and 2b;

FIG. 2d is a cross-section view of a plug module and an electronics module plugged together;

FIG. 3a is a plan view of the electronics module from FIG. 2b;

FIG. 3b is a perspective view of the electronics module from FIG. 3a without the housing cover;

FIG. 3c is a perspective view of the electronics module from FIGS. 3a-3b without a housing cover and with a dismounted circuit board; and

FIGS. 4a-4b are perspective and exploded views, respectively, of the communication module from FIGS. 1a-1d.

### DETAILED DESCRIPTION

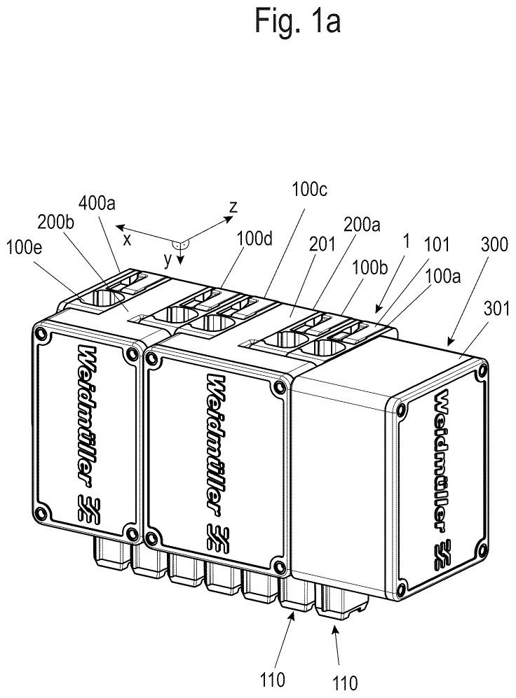

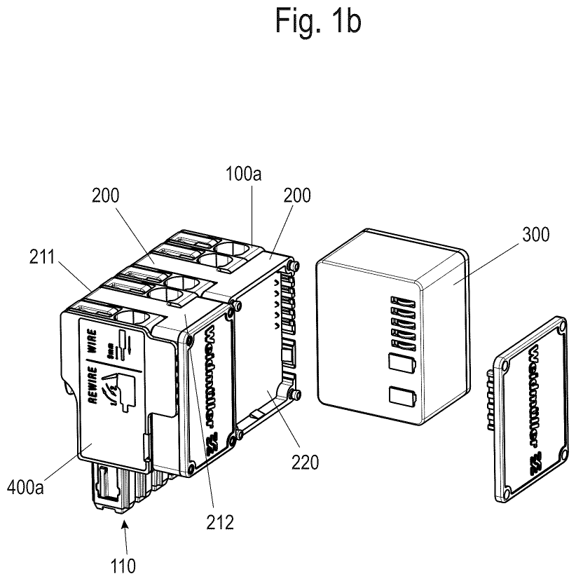

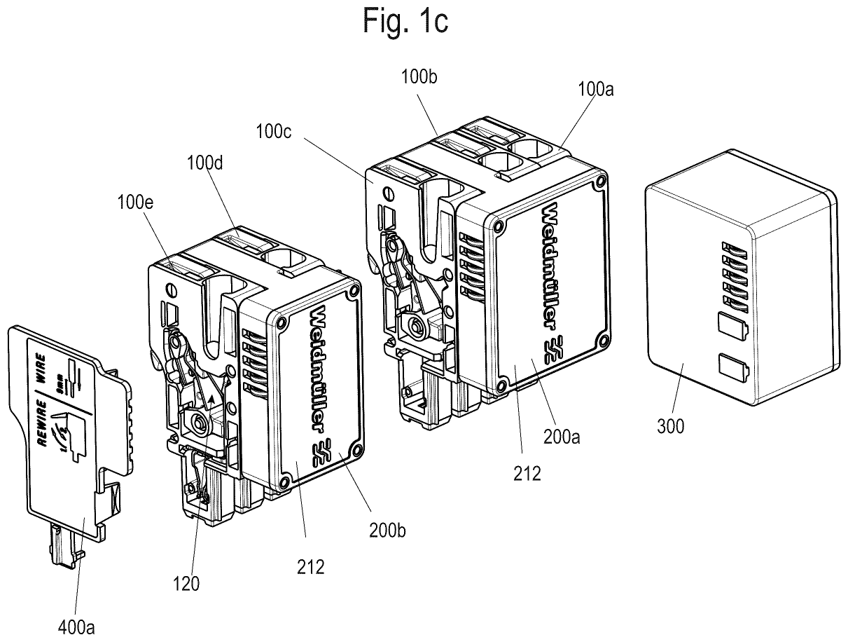

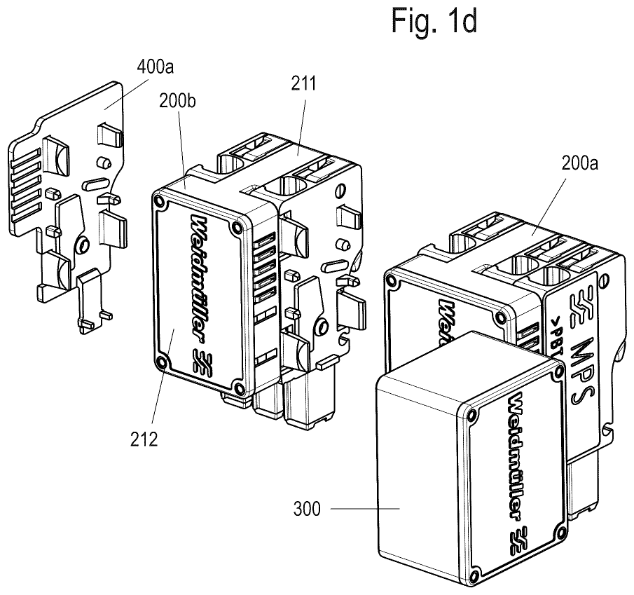

FIG. 1a shows a strip-like modular plug connector 1, which can be plugged together with a mating plug connector that can be configured like a modular circuit board plug connector 1 (not depicted), but that could also be configured as a plug connector for connecting to at least one cable. In this case, the mating plug connector can be arranged on a circuit board and can be connected thereto on one of its sides at least in an electrically conductive manner and where appropriate. mechanically, in particular via one or more solder connections such as on soldering pins.

The modular plug connector 1 of FIGS. 1a-1d is configured in a strip-like manner. It has a plurality of plug connector modules which are mounted in series and are mechanically connected to one another to form the strip. As shown in FIG. 1a, these include from right to left, a communication module (which is optional) 300, two plug modules 100a, 100b, a first electronics module 200a, two additional plug modules 100c, 100d, an additional electronics module 200b and a fifth plug module 100e. To the left, the row is completed by a cover plate 400a, which can be optionally provided. The first plug connector module 100a and/or the last plug connector module can have such a cover plate 400a and/or an end plate or the like in and counter to the series-mounting direction.

It will be understood by those with skill in the art that the plug connector 1 shows an advantageous, but merely exemplary row arrangement. Other row arrangements are conceivable, such as ones without a communication module 300 and/or with a different quantity of plug modules and electronics modules. The plug connector modules-hereinafter also synonymously referred to in short as modules—are mounted in series to one another in a straight series-mounting direction x. The modules 100a, 200a, 300 each have a module housing 101, 201, 301.

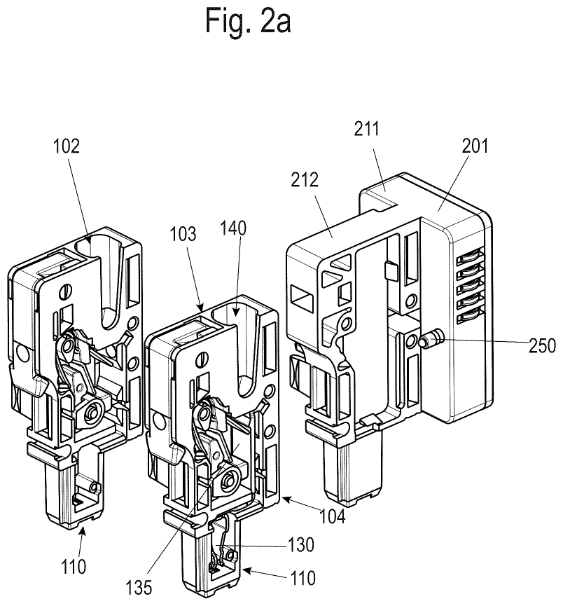

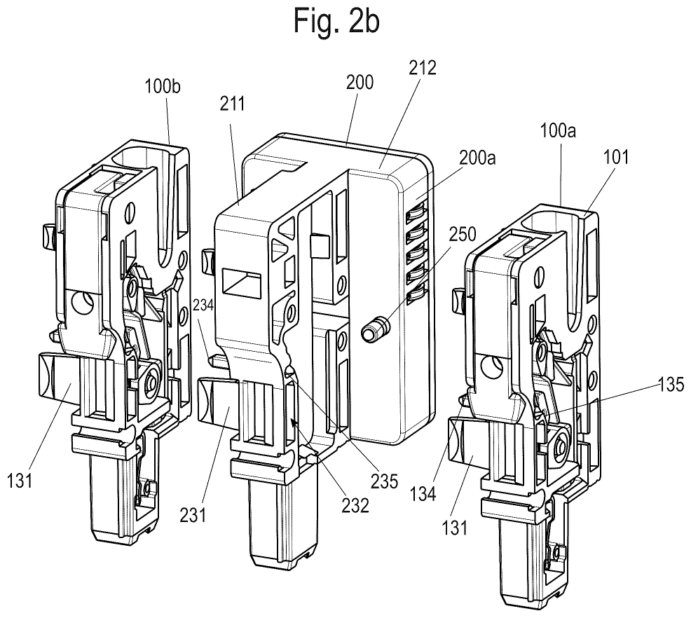

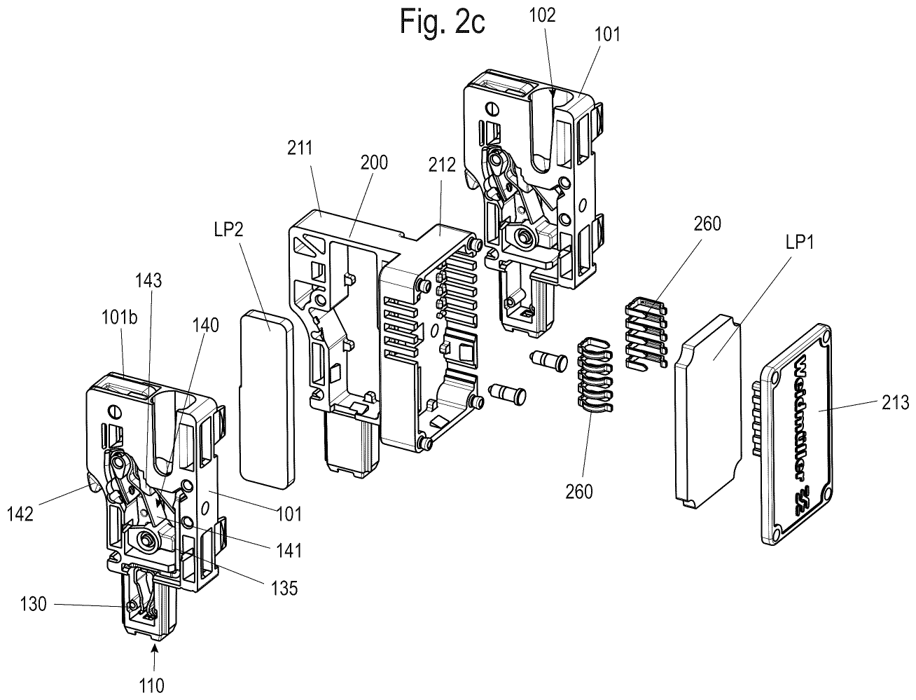

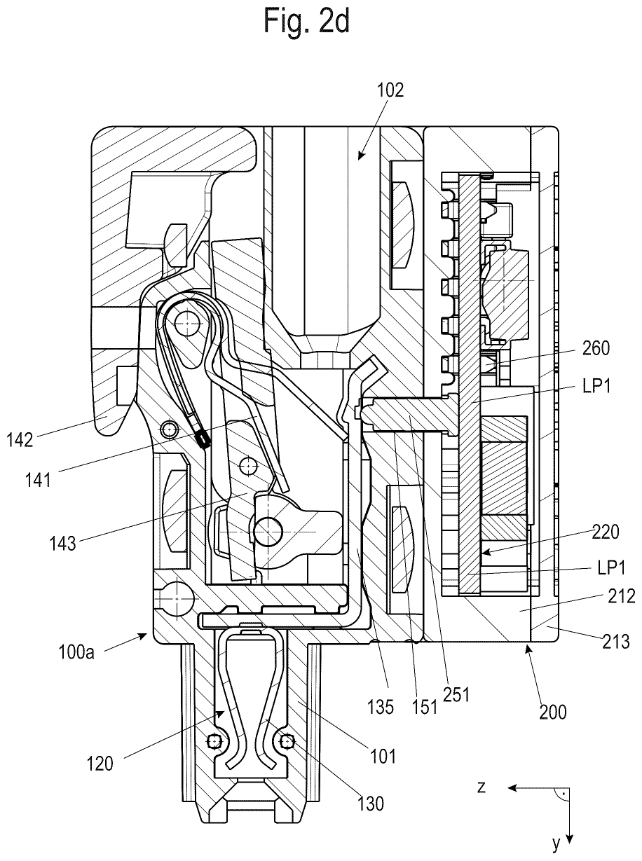

Plug modules such as 100a-100e are preferably plate-like modules which have, in a first plugging direction y perpendicular to the series-mounting direction the housing 101 which in turn has a plugging face 110. They furthermore have at least one metal assembly 120 with one or more plugging contact(s) 130 for plugging together with a corresponding mating plug connector (not depicted). The metal assembly preferably has a conductor terminal 140 to which a stripped conductor end, a crimping terminal or the like can be connected. The plugging contact 130 and the conductor terminal 140 form part of the metal assembly 120 of this plug module, which also conductively connects the two terminals (see FIGS. 1c and 1d and FIGS. 2a and 2b).

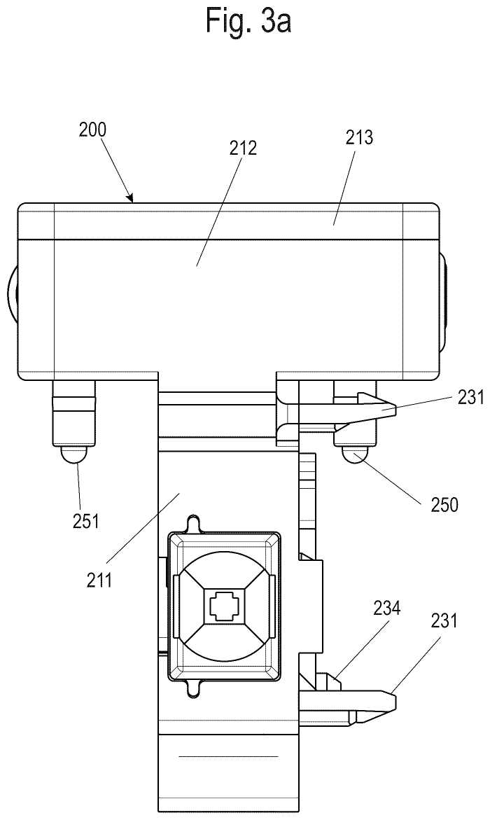

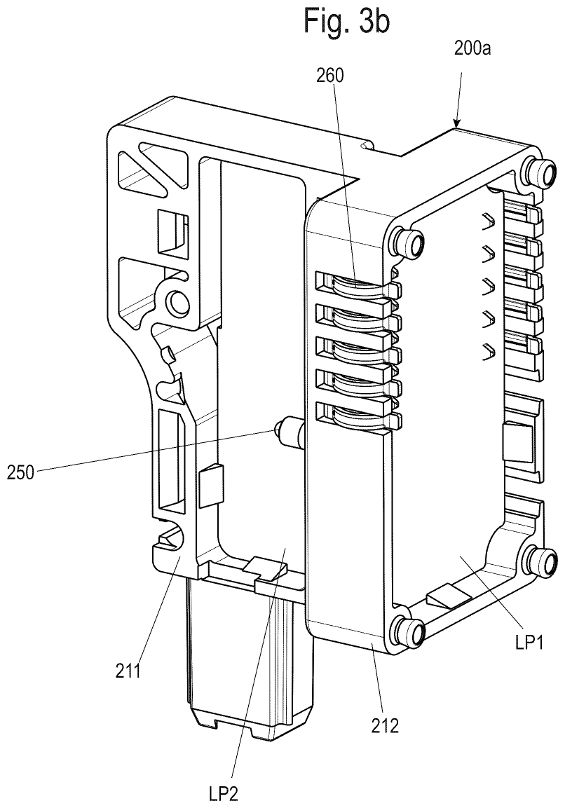

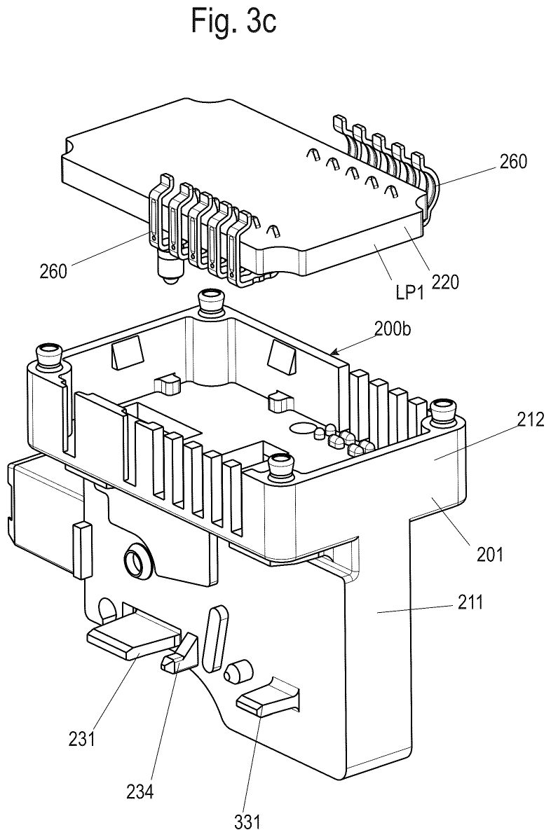

Electronics modules 200a, 200b have at least one housing 201, at least one electronics component or electronics circuit 220 (see FIG. 2d printed circuit board assembly LP1) and one or more measuring devices, in particular one or more measuring contacts 250 or contactless measuring sensors for contacting the metal assembly 120, or arranging in the vicinity of it. Preferably, one of the plugging contacts 130 of the respective electronics module is designed for contacting the metal assembly 120 of a corresponding plug module (see FIGS. 3a-3c), which engages over the electronics module. It would be conceivable for metal assemblies to additionally be arranged in the electronics modules as with the plug modules, so that they then take on a dual function. However, the depicted design is preferred.

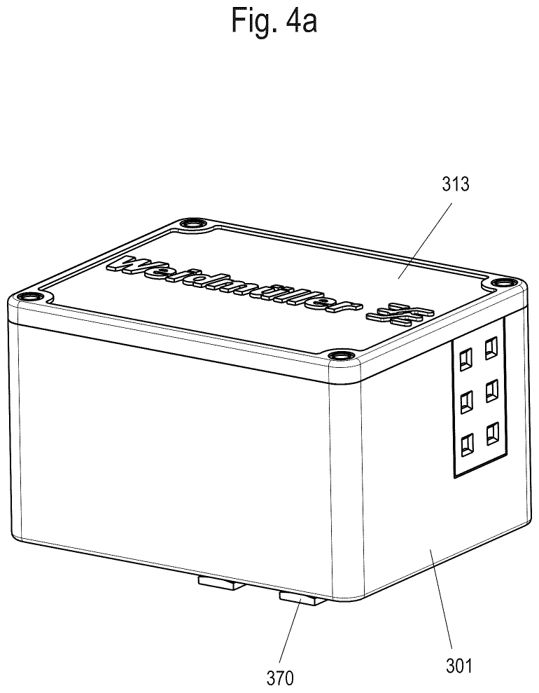

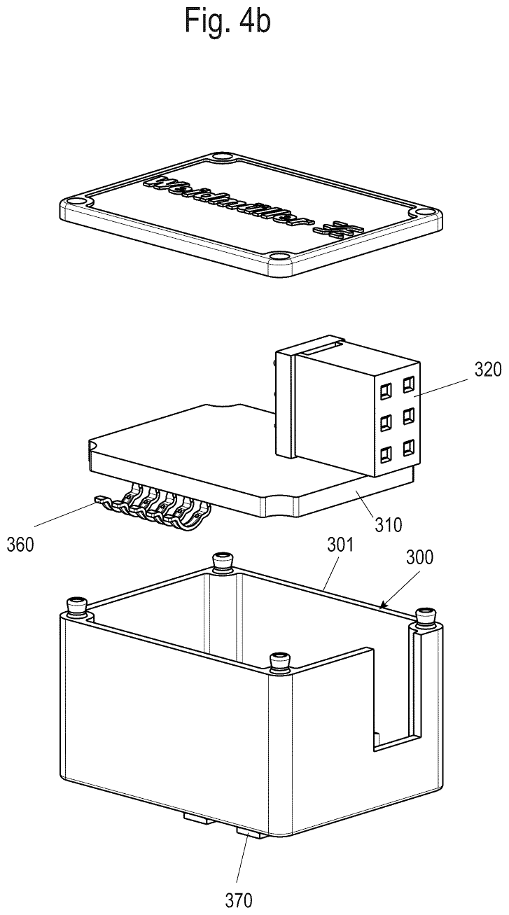

As shown in FIGS. 4a and 4b, the communication module 300 has a housing 301, an electronics circuit 310 and an interface 320, for example a plug interface for connecting a cable or the like, in order to connect the communication module to a higher level control device (not depicted). The optional communication module can be fixed to an electronics housing, e.g. with a tongue-and-groove connection or the like.

The respective module housing 101 of the plug modules 100a, 100b, etc. has in each case the plugging face 110 for connecting the module with a corresponding plugging face of another plug connector 1, which likewise can be modular in structure. To plug together, the plug connector 1 is moved in a plugging direction y perpendicular to the series-mounting direction x and is plugged together to the mating plug connector, e.g. a circuit board plug connector, wherein the plugging contact(s) 130 of the modular plug connector 1 contact one or more mating plugging contacts of the mating plug connector—here the circuit board plug connector 1. The mating plug connector 1 can also be a plug connector for use without a circuit board, for example for the connection of conductor ends, and can form part of a flying plug connector coupling (not depicted here).

The plugging contacts 130 are configured here as one or more tulip or pin contact(s). Mixed forms with pin and tulip contacts are also conceivable, as are shielding contacts.

Several metal assemblies per plug module can also be provided.

In the respective plug connector module, the plugging contact(s) 130 are electrically conductively connected to the respective conductor terminal 140 for connection of at least one (stripped) conductor end, for example via at least one busbar 135 (see FIGS. 2c and 2d). The conductor terminal 140 can be configured as a direct plug terminal (push-in technology having a compression spring 141 and an actuating arrangement for opening a clamping point having a lever 142 and a pusher 143 with which pressure can be exerted onto the compression spring 141 to open a clamping point between the busbar 135 and the compression spring 141 for contacting the conductor (not depicted here). The conductor terminal could, however, also be formed in another connection technology, such as a tension spring terminal, IDC terminal or a screw terminal (not depicted here). The conductor terminal can be configured such that its clamping spring 141 can be locked in the open position and can be released from the locked position upon insertion of the conductor to contact the conductor.

The module housings 101 have on the side facing away from the plugging face, which is advantageous but not obligatory, an insertion aperture 102 for inserting the conductor end into the clamping point in the module housing 101.

The module housings 101 are arranged alongside one another in the series-mounting direction x having a first series-mounting side, which is also referred to hereinafter as the series-mounting front side 104 (FIG. 2a). Furthermore, they have a second series-mounting side, which is also referred to hereinafter as the series-mounting rear side 103, which can be formed as a substantially closed wall. Variations will be explained hereinafter.

The series-mounting front side 104 also forms a type of wall, but in sections it can be formed to be more open than the more closed series-mounting rear side 103, since, amongst other things, metal parts of the metal assembly 120 can be mounted from the series-mounting front side 104. These can additionally be configured to be wider in the series-mounting direction, if the series-mounting front side 104 is not also formed to be as closed as the series-mounting rear side 103, which can then support the metal parts in this direction.

In order to be able to series-mount the module housings 101 of the plug modules 100a onto one another (and also the electronics modules 200a, 200b, etc.) so that they solidly and securely form a strip-like modular plug connector 1, they have corresponding mechanical connecting means on the two series-mounting sides, being the series-mounting front side 104 and the series-mounting rear side 103.

The members 131 and 136 to be described hereinafter can be configured on the plug modules 100a-100e and on the electronics modules 200a-200b. They could also be configured on the communication modules 300 that is affixed to one of the electronics modules 200a in a different manner.

Here, the mechanical connecting means comprise several—here four—locking hooks 131, 231, 331 which are arranged on the series-mounting rear side 103 and protrude from it in the series-mounting direction x. The locking hooks 131, 231, 331 are designed for the purpose of locking into locking traps/locking recesses 132, 232 when plugging together adjacent module housings. The locking traps/locking recesses 132 are formed in the series-mounting front side 104 of the adjacent module housings 101 which are mounted in series. The latching hooks can be released; however, it is also envisaged to form them to not be released (FIG. 2b).

In addition, one or more pins 134, 234, which protrude from the series-mounting rear side 103, 203, are provided for the purpose of engaging in a form-fitting manner and preferably also in a force-fitting manner in corresponding receiving holes 135, 235 on the series-mounting front side 104, 205.

If several of the pins 134, 234 and receiving holes 135, 235 are provided, these can have an identical or different cross-section.

Securing adjacent module housings 101a, 101b, 201 in the higher-level modular plug connector 1 can be ensured by a combination of a locking connection with locking hooks 131, 231 and locking traps 132, 232, as well as a press-fit connection with (press) pins 134, 234 and receiving holes 135, 235.

The module housing 201 of the electronics modules 200a, 200b have two sections or limbs 211, 212 configured at an angle, in particular a right angle, to one another. One housing limb is a series-mounting limb 211, which can be configured in a plate-shaped manner and can be series-mounted between two of the plug modules. The other limb is a transverse limb 212 orientated perpendicular thereto.

The series-mounting limb 211 of the respective electronics modules preferably has a mechanical connector which correspond to the mechanical connector of the plug modules 100a-100e such that the respective series-mounting limb 211 can be series-mounted between two adjacent plug modules and can be mechanically connected to them like one of the plug modules 100a, 100b. In addition, it can also have a circuit board LP2.

The mechanical connector of the series-mounting limb 211 of the electronics module therefore correspondingly include here, by way of example, one or more of the locking hooks 231, which are configured for the purpose of locking into locking traps/locking recesses 132 when plugging together adjacent module housings. The locking traps/locking recesses 132 are formed in the series-mounting front side 104 of the adjacent module housings 101 of the adjacent plug module—e.g. 100c—which are arranged alongside one another. In addition, the electronics module has corresponding locking recesses/locking traps. Furthermore, it can also have one or more pins 234 and one or more of the receiving holes 235.

It can be envisaged that a plugging face is configured without contacts on the series-mounting limb 211.

The connectors on the electronic modules 200a, 200b and on the plug modules 100a-100e, are advantageous and offer a secure connection. However, they should be understood as examples that can be formed differently.

The transverse housing section or transverse limb 212 preferably extends on one or both sides (viewed in the plugging direction, there arises an L-shape or, as depicted, a T-shape) transverse to the series-mounting limb 211.

The transverse housing section or transverse limb 212 can be designed to rest in the z-direction behind or on one or more of the housings 101 of the adjacent plug modules 100a, 100b, 100c or to virtually engage over one or multiple of the plug modules on this rear side in a “piggyback” manner. The transverse housing section or transverse limb 212 viewed from the perspective of the series-mounting limb 211, engages over one or two adjacent plug modules 100a, 100b in and/or against the series-mounting direction. The transverse housing section 212 can also engage over more than two adjacent plug modules 100a, 100b (not depicted here).

The transverse housing section 112 preferably rests on a housing side of the plug modules 100a, 100b on which no actuation member to be operated is configured. The arrangement of the modules should thus advantageously be envisaged such that field wiring is not impeded.

In this manner, a modular plug connector can be formed as in FIG. 1a. The series-mounting limbs 211 are each arranged between two plug modules e.g. 100b, 100c.

In one or both housing sections 211, 212, no, one or multiple electronic units can be configured in each case, in particular one or multiple electronic units 220, which can each comprise at least one circuit board LP1, LP2.

The transverse limb 212 can preferably have a cover 213, which can be released from the module housing 201 and in particular can be affixed to the module housing 201 in a locking manner. In this way, the electronics circuit or where applicable at least one of the circuit boards LP1 is always easily accessible in the transverse limb 212, even when the plug connector is connected.

One of the limbs, preferably the transverse limb 212, can have one or more measuring devices, in particular one or more measuring contacts 250, 251 (see e.g. FIG. 3a). The measuring contact(s) 250, 251 or test contacts can be configured as resilient contact pins.

The measuring contact(s) 250, 251 are each designed to engage corresponding recesses or holes 150, 151 of the next one or two housings of the plug modules 100a-100e in the row and to contact one or multiple conductive components of the metal assembly 120 in the respective module housing 101, which are configured in the respective module housing 101.

One or more contactless measuring sensors which do not contact the metal assembly can be alternatively/optionally provided as measuring device(s) It is preferred that they be designed as shown, except that they do not touch the metal assembly, but end just before the metal assembly. However, they also extend from the electronics housing into the overlapping plug housing.

These measuring contacts 250, 251 contact the busbar 135 of the metal assembly 120. The measuring contacts, in particular the resilient contact pins, can be designed to come into resilient contact with the surface of an element of the respective metal assembly 120, in particular on the busbar 135 in the vicinity of the conductor terminal, when inserted into the respective module housing 101. A voltage or the temperature can thus be measured at the conductor terminal 140 of the respective electronics module 201, 202. If a module housing of a plug module has a number of metal assemblies 120, a corresponding number of measuring contacts can also engage in this plug module (not depicted) and contact the metal assembly there.

In this way, at least one measurement value can be detected in a simple manner at the metal assembly 120 and an evaluation can be carried out on the basis of this/these measurement(s). For example, a status can be displayed on one or more LEDs (not shown here) or the like as an output device.

The measuring contacts 250, 251 can be used in various ways. For example, they can be used preferably as a resilient measuring element of a temperature sensor, which can be conductively connected to an evaluation device or electronics on the circuit board LP1 (FIG. 2c). The housing 201 of the electronics modules can have a display device such as an LED to display an operating state, which can be related to a limit value of the temperature measurement.

By means of the resilient measuring contacts 250, 251, thermal coupling is produced between the busbar 135 of the metal assembly of the associated plug module—e.g. 100b—in the conductor terminal region.

The transverse limbs 212 of the electronics modules 200 and of the communication module 300, when applicable, can also optionally have one or more bus contacts, e.g. bus spring contacts 260, on one or both sides. This is to form a data and/or energy bus across a number of the electronics modules 200a-200bb and, where applicable, up to the communication module 300 to transmit measurement values to a higher-level control system. A connection is resiliently produced between neighboring bus spring contacts 260 when series-mounting is included. The bus spring contacts 260 can be arranged on the circuit board LP1 and configured differently in the two directions (+x, −x) in which they make contact, e.g. flat on one side and resiliently bent on the other. The circuit board LP1 is then contacted with the flat side, while the bent sections can be adjacent one another at neighboring electronics modules.

It is conceivable to retrieve measurement values from a higher-level control system via the bus formed in this way (e.g. I2C). The bus contacts 260 on the side of the transverse limbs 212 can enable daisy chaining of multiple “smart plates” or electronic plates 200a-200b as these automatically contact the neighboring smart plates or electronic plates 200a-200b.

At the end of a plug connector 1 configured with smart plates or electronic plates 200a-200b, at least one of the “communication plates 300” is provided, which can communicate with the bus contacts 260 of the individual electronic plates 200 via the bus contacts 360. A controller can be present in the communication plate 300, which cyclically retrieves/checks the temperature values of all temperature sensors. The temperature values can be retrieved via BUS (e.g. SPI) by a pluggable interface, e.g. to the device to which the plug connector 1 is to be connected. In addition, an algorithm for assessing the temperatures can be provided on the controller. This algorithm can be based on expert knowledge, historical data or both and can be used to decide whether an anomaly or unexpected temperature is present, both of which can indicate a defect. The result of the assessment can also be read from the device. The communication plate may also have a housing 301 with a removable cover 313.

1-16. (canceled)

17. A modular plug connector having a strip-shaped configuration and being adapted to plug together with a corresponding mating plug connector, the modular plug connector comprising a plurality of modules arranged in series and mechanically connected to one another directly with mechanical connecting mechanisms to form the strip-shaped configuration, comprising a plurality of plug modules and one or more electronics modules, wherein the electronics module each have two housing limbs orientated at an angle relative to one another, one being a series-mounting limb that can be mounted in series between two of the plug modules and the other being a transverse limb orientated at a right angle thereto and which is arranged on a housing side of one or more of the plug modules, the housing side being orientated at a right angle relative to the series-mounting direction.

18. The modular plug connector according to claim 1, wherein the plurality of plug modules each have a metal assembly with at least one plug terminal and at least one conductor terminal, the transverse limb of the respective associated electronics module for the plug module having one of at least one measuring contact and a contactless measuring sensor to contact the metal assembly of the respective plug module that it engages over, that it comes to rest with, or that is situated in the vicinity of the metal assembly of the respective plug module when the module is plugged in.

19. The modular plug connector according to claim 1, wherein a module housing of the electronics module has an L-shape or a T-shape in at least one side view in the plugging direction of the plug connector.

20. The modular plug connector according to claim 3, wherein the series-mounting limb of each electronics module and the module housings of each plug module have corresponding mechanical connecting mechanisms at which they can be affixed to one another in a row.

21. The modular plug connector according to claim 2, wherein the at least one measuring contact is a pin contact which engages the module housing of the plug module it engages over to resiliently contact a busbar of the respective metal assembly.

22. The modular plug connector according to claim 2 wherein the at least one measuring contact is a pin contact which engages the module housing of the plug module it engages over, wherein it is arranged in the vicinity of the metal assembly without touching it.

23. The modular plug connector according to claim 1, wherein the one or more electronics modules has an evaluation device for evaluating a measurement value tapped at one of the plug modules.

24. The modular plug connector according to claim 7, wherein the one or more electronics modules includes a display device having at least one LED to display the result of the evaluation of a measurement value.

25. The modular plug connector according to claim 9, wherein the transverse limbs of the one or more electronics modules each have bus contacts.

26. The modular plug connector according to claim 9, wherein a plurality of electronics modules are provided the transverse limbs of the plurality of electronics modules adjoin one another and the bus contacts of the electronics modules contact one another in and against the series-mounting direction, whereby when the plug connector is mounted together, one of a data bus, an energy bus, or both extends over the electronics modules to a communication module of the plug connector to which a higher-level unit can be connected.

27. The modular plug connector according to claim 1, wherein the mechanical connecting mechanisms have one or more locking hook and one or more corresponding locking trap.

28. The modular plug connector according to claim 1, wherein the mechanical connecting mechanisms have one or more peg and one or more corresponding receiving hole.

29. A method for using the one or more electronics modules of a plug connector according to claim 1, wherein the one or more electronics modules is used to perform a measurement and one of evaluate a measurement result, display a measurement result, and evaluate and display a measurement result.

30. The method according to claim 13, wherein the measurement is or includes a measurement of temperature.

31. The method according to claim 13, wherein the measurement is or includes a measurement of voltage or current.

32. A method of measuring the voltage or the temperature at or of the current through a conductor terminal at a modular plug connector, comprising the steps of:
a) providing modular plug connector;
b) measuring a temperature, a voltage or a current at a metal assembly of a plug module having a measuring device which contacts or is arranged in the vicinity of the metal assembly of the plug module into which it is plugged; and
c) at least one of displaying the measurement, displaying a result of the measurement, or forwarding the measurement to a communication module.
